(19) United States
(12) Patent Application Publication
(10) Pub. No.: US 2023/0306305 A1
(43) Pub. Date: Sep. 28, 2023

(54) Functional Nonlinear Wiener-Based Signal Filtering

(71) Applicant: University of Florida Research Foundation, Incorporated, Gainesville, FL (US)

(72) Inventor: Jose C. Principe, Gainesville, FL (US)

(21) Appl. No.: 18/124,426

(22) Filed: Mar. 21, 2023

Related U.S. Application Data
(60) Provisional application No. 63/269,786, filed on Mar. 23, 2022.

(51) Int. Cl. G06N 20/00

(52) U.S. Cl. CPC G06N 20/00

(57) ABSTRACT

Various embodiments of the present disclosure provide methods, apparatuses, and computer program products for functional nonlinear Wiener-based signal filtering, with which an estimate of a target signal may be produced. Various embodiments involve generation and/or implementation of a functional Wiener filter for continuous time series data filtering, such as signal prediction or signal denoising. In various embodiments, the functional Wiener filter is configured through a reproducing kernel Hilbert space employing a similarity measure that embeds signal statistical information, such as the correntropy measure. With this, the functional Wiener filter is uniquely applicable to the space of nonlinear mappings.

### CROSS-REFERENCE TO RELATED APPLICATIONS

The present application claims priority to U.S. Provisional Application Ser. No. 63/269,786, titled “FUNCTIONAL NONLINEAR WIENER-BASED SIGNAL FILTERING,” filed Mar. 23, 2022, the contents of which are incorporated herein by reference in their entirety.

### TECHNOLOGICAL FIELD

A functional Wiener filter (FWF) is a nonlinear universal filter that can be trained. Various embodiments of the present disclosure provide for improved time series data filtering that may be applied by devices where processing capability and power consumption may be constrained, such as Internet-of-Things (IoT) devices, for example.

### BACKGROUND

Various embodiments of the present disclosure address technical challenges relating to computational efficiency and throughput of continuous time series data filtering and real world applications thereof. Additionally, various embodiments address technical limitations of linear filtering techniques.

### BRIEF SUMMARY

Various embodiments of the present disclosure provide methods, processes, operations, systems, apparatuses, computer program products, and/or the like for nonlinear signal processing based at least in part on generating and implementing a functional Wiener filter for producing a nonlinear estimate of a target signal. For example, various embodiments may be applied in continuous time series data filtering, such as for signal prediction or signal denoising. In various embodiments, a functional Wiener filter is generated and configured through a reproducing kernel Hilbert space (RKHS) and used to perform the functional nonlinear Wiener-based signal filtering. In particular, the functional Wiener filter may be generated through defining a lagged RKHS employing a similarity measure that embeds signal statistical information, such as a correntropy measure. With this, the functional Wiener filter is configured to be applicable to the space of nonlinear mappings. Through this, various embodiments provide an analytic solution that has a constant complexity and that is minimally- or non-reliant upon error calculations.

As a result, various embodiments are well suited to easy implementations in field programmable gate arrays (FPGAs) with minimal configurations, such that continuous time series data filtering (e.g., signal prediction, signal denoising) according to various embodiments can be deployed cheaply and in ultra-low power devices (e.g., application-specific integrated circuits, or ASICs). That is, generally, various embodiments provide computationally efficient nonlinear filtering for devices that may be associated with processing constraints, power constraints, and/or the like. Experimental results discussed within the present disclosure show that nonlinear filtering of continuous time series data using functional Wiener filters in accordance with various embodiments described herein performs at least on par with existing filtering techniques while requiring fewer computational resources.

### BRIEF DESCRIPTION OF THE DRAWINGS

Having thus described the present disclosure in general terms, reference will now be made to the accompanying drawings, which are not necessarily drawn to scale.

FIG. 1 is a diagram of a system architecture that can be used in conjunction with various embodiments of the present disclosure;

FIG. 2 is a schematic of a computing entity that may be used in conjunction with various embodiments of the present disclosure;

FIG. 3 is a process flow for nonlinearly filtering data using a functional Wiener filter, in accordance with various embodiments of the present disclosure;

FIG. 4 is a process flow for generating a functional Wiener filter configured to nonlinearly filter data with improved computational complexity, in accordance with various embodiments of the present disclosure;

FIG. 5 illustrates an example of continuous time series data that may be processed according to nonlinear signal processing with a functional Wiener filter, in accordance with various embodiments described herein;

FIG. 6 illustrates an auto-correntropy function over different lags of an example continuous time series data that may be used in generating and using a functional Wiener filter for nonlinear signal processing, in accordance with various embodiments of the present disclosure;

FIG. 7 illustrates experimental performance of various embodiments of the present disclosure compared to existing filtering techniques;

FIG. 8 illustrates experimental performance of various embodiments of the present disclosure compared to existing filtering techniques;

FIG. 9 illustrates an example of continuous time series data that may be denoised via nonlinear signal processing with a functional Wiener filter, in accordance with various embodiments described herein;

FIG. 10A illustrates experimental performance of various embodiments of the present disclosure compared to existing filtering techniques; and

FIG. 10B illustrates experimental performance of various embodiments of the present disclosure compared to existing filtering techniques.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. General Overview and Exemplary Technical Advantages

Various embodiments of the present disclosure provide a functional Wiener filter that can be applied for generally nonlinear signal filtering, and specifically with minimum mean square error (MMSE) estimation in signal filtering applications, for example. In various embodiments, the functional Wiener filter enables improved estimation and filtering, at least with respect to computational complexity, operational efficiency, power requirements, and operation throughput. Existing filtering techniques, such as the Wiener-Hopf method for solving integral equations, may be effective in solving for the optimal parameter function during minimum mean square error estimation; however, such techniques are rather complex, resulting in computational/processing inefficiencies and relatively significant power consumption. Meanwhile, other existing filtering techniques and filters are limited to linear parameters. For example, in digital signal processing using finite impulse response filters, a Wiener-based solution coincides with least squares (as proved by the Wiener-Kinchin theorem), although the solution is performed in the space of the input data. As such, the corresponding Wiener filter and similar filters in other existing techniques rely upon linear parameters and therefore are not universal functional approximators.

Thus, by providing a relatively low complexity solution that can be used in nonlinear applications, various embodiments provide further technical advantages at least with respect to wider applicability, in addition to the previously-identified improvements to computational complexity, power consumption, and the like. In various embodiments, the extended applicability to nonlinear solutions and functions provided by the functional Wiener filter in accordance with various embodiments described herein is enabled at least in part by generating the functional Wiener filter through definition and generation of a reproducing kernel Hilbert space (RKHS). The following provides an example definition of an RKHS. Let E be a non-empty set, and κ(u, v) a function defined on E×E that is non-negative definite. Due to the Aronszajn theorem, κ(u, v) uniquely defines a RKHS, referred to as [symbol] , such that κ(⋅, v)∈ [symbol] and for any g∈ [symbol] [symbol] g, κ(⋅, v) [symbol] =g (v). Therefore, a reproducing kernel Hilbert space (RKHS) may be understood as a special Hilbert vector space associated with a kernel such that it reproduces (via the inner product) in the space [symbol] κ(⋅, u), K(⋅, v) [symbol] =κ(u, v), or equivalently, as a space where every point evaluation functional is bounded. The RKHS framework provides a natural link between stochastic processes and deterministic functional analysis.

Existing uses of the RKHS methodology has been limited to linear solutions in MMSE and signal processing applications. For instance, the RKHS methodology has been introduced in statistical signal-processing and time-series analysis with an idea that there exists a congruence map between the set of random variables spanned by the random process {X(t), t∈T} with covariance function R (t, s)=E[X(t)X(s)] and the RKHS of functions spanned by the set {R (⋅, t), t∈T} denoted as [symbol] . The kernel expresses the second-order statistics of the data through the expected value (a data-dependent kernel), and this RKHS offers an elegant functional analysis framework for minimum variance unbiased estimation of regression coefficients, least squares estimation of random variables, detection of signals in Gaussian noise, and others. Despite this, [symbol] is unfortunately still defined in the space of the input data, so this existing RKHS methodology also yields only linear solutions to the regression problem, thus lacking any practical improvement.

Various embodiments described herein address at least the above-identified technical limitations and provide a functional Wiener filter that is configured for nonlinear signal processing and filtering to provide nonlinear solutions. In various embodiments, kernel adaptive filter (KAF) concepts that yield a RKHS according to a covariance function are uniquely adapted and improved upon to generate a RKHS that is nonlinearly related to the data space. Further, unlike KAF concepts that provide models that approximate the minimum least mean solution using search techniques in a RKHS defined by the Gaussian kernel, various embodiments described herein directly utilize a data-dependent kernel function based at least in part on a similarity measure that incorporates full data statistics, such as the correntropy function. With the correntropy function, for example, a RKHS of deterministic functions is defined, even when the input data is a random variable. In various embodiments, the correntropy function is extended past its typical use as a robust cost function in adaptive signal processing and is applied to generate functional Wiener filters in the space of nonlinear mappings, without using Wiener-Hopf spectral factorization. The present disclosure herein describes how to pose and derive the generation of a functional (nonlinear) Wiener filter and how to implement it directly from data samples, thereby effectively extending the MMSE estimation to nonlinear universal approximators. The present disclosure further includes experimental results that show performance of functional Wiener filters in accordance with various embodiments described herein being at least on par to that of KAF filters, but providing technical advantages over KAF filters and other filtering techniques by featuring a smaller computational complexity.

### II. Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

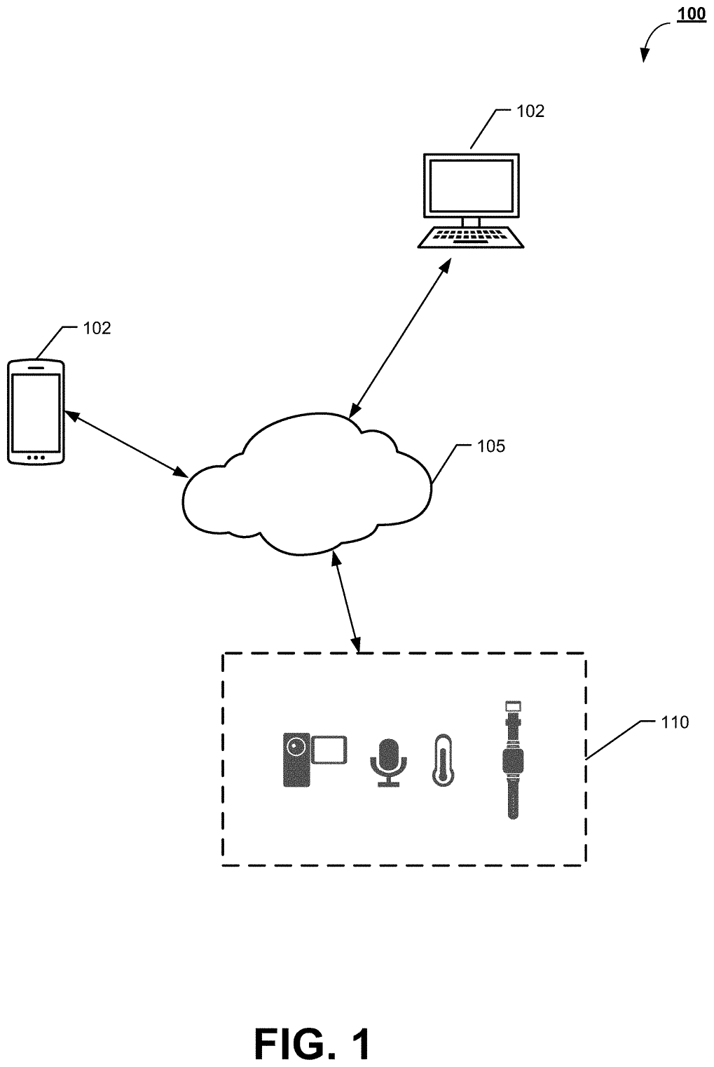

FIG. 1 provides an illustration of a system architecture 100 that may be used in accordance with various embodiments of the disclosure. Here, the architecture 100 includes various components involved in generating and implementing functional Wiener filters for nonlinear filtering of signals. In various embodiments, the architecture 100 involves generation and implementation of functional Wiener filters to nonlinearly filter continuous time series data, such as sensor data streams for example, for signal prediction applications, signal estimation applications, signal denoising applications, and/or the like. Accordingly, in various embodiments, the architecture 100 includes one or more data collection devices 110 that are configured to collect continuous time series data, sensor data streams, and/or the like. As illustrated, the data collection devices 110 may be in network communication via a network 105 with one or more user computing entities 102. In various embodiments, the data collection devices 110 are configured to collect continuous time series data, filter the continuous time series data to produce filtered data using one or more functional nonlinear Wiener filters, and provide the filtered data via the network 105 to the one or more user computing entities 102. The filtered data may additionally or alternatively be distributed among other data collection devices 110 for various actions to be performed. For instance, the data collection devices 110 are components within an Internet-of-Things (IoT) system that may communicate with each other via IoT network communication, and a user computing entity 102 may be configured to remotely communicate with and/or operate the data collection devices 110 (e.g., to control aspects of data collection).

In some example embodiments, the data collection devices 110 are configured to collect continuous time series data and provide the data to the one or more user computing entities 102 whereupon the one or more user computing entities 102 may be configured to generate and implement a functional Wiener filter to produce filtered data with relatively low and constant complexity. In some other example embodiments, the user computing entities 102 are configured to generate a functional Wiener filter and provide the functional Wiener filter to the data collection devices 110 (e.g., via the network 105) for implementation at the data collection devices 110.

Generally, a functional Wiener filter is generated based at least in part on defining and generating a RKHS, and in various embodiments, historical data samples may be used to generate the RKHS. As such, in some example embodiments, the user computing entities 102 are configured to store historical data samples in a memory device, in a database, and/or the like, and the historical data samples may be accessed by the user computing entities 102 themselves and/or by the data collection devices 110 in order to generate an RKHS from which a functional Wiener filter may be generated. In various embodiments, the user computing entities 102 may be configured to access training datasets and/or testing datasets to generate a functional Wiener filter.

As noted, the user computing entities 102 and the data collection devices 110 may communicate with one another over one or more networks 105. Depending on the embodiment, these networks 105 may comprise any type of known network such as a land area network (LAN), wireless land area network (WLAN), wide area network (WAN), metropolitan area network (MAN), wireless communication network, the Internet, etc., or combination thereof. In addition, these networks 105 may comprise any combination of standard communication technologies and protocols. For example, communications may be carried over the networks 105 by link technologies such as Ethernet, 802.11, CDMA, 3G, 4G, 5G or digital subscriber line (DSL). Further, the networks 130 may support a plurality of networking protocols, including the hypertext transfer protocol (HTTP), the transmission control protocol/internet protocol (TCP/IP), or the file transfer protocol (FTP), and the data transferred over the networks 130 may be encrypted using technologies such as, for example, transport layer security (TLS), secure sockets layer (SSL), and internet protocol security (IPsec). As discussed, the networks 105 may include an IoT network that enables communication between data collection devices 110 that are IoT devices. Those skilled in the art will recognize FIG. 1 represents but one possible configuration of a system architecture 100, and that variations are possible with respect to the protocols, facilities, components, technologies, and equipment used.

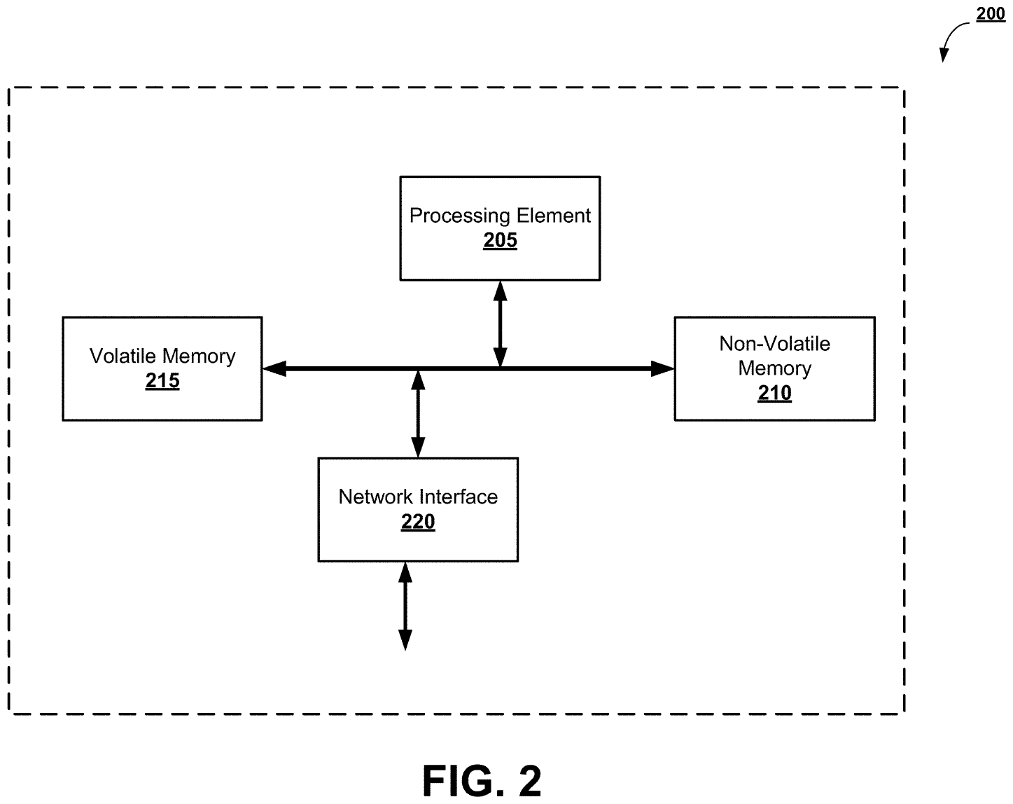

FIG. 2 provides a schematic of an exemplary apparatus 200 that may be used in accordance with various embodiments of the present disclosure. In particular, the apparatus 200 may be configured to perform various example operations described herein to generate a functional Wiener filter configured to be used for nonlinear filtering of continuous time series data and/or to implement a functional Wiener filter in nonlinear filtering. In some examples, the apparatus 200 may perform example operations for defining and/or generating a RKHS with which a functional Wiener filter may be generated. In various embodiments, the apparatus 200 may be associated with one or more constraints with respect to computational and/or processing capability (e.g., floating operations per second, or FLOPS), power consumption, and/or the like, and thus, the apparatus 200 may be configured to perform nonlinear filtering with a functional Wiener filter in accordance with various embodiments described herein in order to satisfy said constraints, in various examples.

In general, the terms computing entity, entity, device, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the field should appreciate that the apparatus 200 shown in FIG. 2 may be embodied as a plurality of computing entities, tools, and/or the like operating collectively to perform one or more processes, methods, and/or steps. As just one non-limiting example, the apparatus 200 may comprise a plurality of individual data tools, each of which may perform specified tasks and/or processes.

Depending on the embodiment, the apparatus 200 may include one or more network and/or communications interfaces 220 for communicating with various computing entities, such as by communicating data, content, information, and/or similar terms used herein interchangeably that can be transmitted, received, operated on, processed, displayed, stored, and/or the like. Thus, in certain embodiments, the apparatus 200 may be configured to receive data from one or more data sources and/or devices as well as receive data indicative of input, for example, from a device.

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the apparatus 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), 5G New Radio (5G NR), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The apparatus 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the apparatus 200 includes or is in communication with one or more processing elements 205 (also referred to as processors, processing circuitry, and/or similar terms used herein interchangeably) that communicate with other elements within the apparatus 200 via a bus, for example, or network connection. As will be understood, the processing element 205 may be embodied in several different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware, computer program products, or a combination thereof, the processing element 205 may be capable of performing steps or operations according to embodiments of the present disclosure when configured accordingly.

In various embodiments, the apparatus 200 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 210 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 210 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In particular embodiments, the non-volatile memory media 210 may also be embodied as a data storage device or devices, as a separate database server or servers, or as a combination of data storage devices and separate database servers. Further, in some embodiments, the non-volatile memory media 210 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the apparatus 200 may further include or be in communication with volatile media (also referred to as volatile storage, memory, memory storage, memory circuitry and/or similar terms used herein interchangeably). For instance, the volatile storage or memory may also include one or more volatile storage or volatile memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like.

As will be recognized, the volatile storage or volatile memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 205. Thus, the databases, database instances, database management system entities, data, images, applications, programs, program modules, scripts, source code, object code, byte code, compiled code, interpreted code, machine code, executable instructions, and/or the like may be used to control certain aspects of the operation of the apparatus 200 with the assistance of the processing element 205 and operating system.

As will be appreciated, one or more of the computing entity's components may be located remotely from other computing entity components, such as in a distributed system. Furthermore, one or more of the components may be aggregated, and additional components performing functions described herein may be included in the apparatus 200. Thus, the apparatus 200 can be adapted to accommodate a variety of needs and circumstances.

### III. Exemplary Technical Foundations of Various Embodiments

Various concepts relating to linear prediction for continuous time series time in a RKHS present various technical limitations, and various embodiments of the present disclosure build upon such concepts to provide a functional Wiener filter configured for nonlinear prediction and nonlinear filtering of continuous time series data, such as sensor data streams collected by data collection devices 110, for example. In various embodiments, generation and implementation of a functional Wiener filter for nonlinear prediction and filtering builds upon concepts associated with kernel adaptive filtering (KAF), such concepts being described herein.

In KAF applications, the goal is to construct a function ƒ: [symbol] ^{L}→ [symbol] based at least in part on a real sequence {(xᵢ,dᵢ)}ᵢ₌₁^{N} of examples or data samples (xᵢ, dᵢ)∈S×D, where D is a compact subset of [symbol] and S a compact subspace of [symbol] ^{L}. A kernel is a continuous, symmetric, positive definite function κ: S×S→ [symbol] that defines a RKHS that will be denoted by [symbol] . Here, the Gaussian function

$$G ( x , {x}_{i} ) = exp ( - \frac{{‖ x - {x}_{i} ‖}^{2}}{2 {σ}^{2}} )$$

may be used as the kernel, where σ is the kernel size or bandwidth. Generally, in various examples, kernel adaptive filtering (KAF) implements nonlinear filtering on discrete time series by mapping the input sampled data {xᵢ}ᵢ₌₁^{N} to the RKHS denoted by [symbol] using a positive definite kernel K, and by using search techniques based at least in part on the gradient and/or Hessian information to adapt the functional parameter.

The kernel K maps each embedding vector xᵢ of size L, to a function in the RKHS [symbol] , denoted as G(xᵢ,⋅), where the “.” in the second argument means that a data point is represented by a Gaussian function centered at xᵢ, not a real value. The inner product in the RKHS [symbol] of two such functions centered at xᵢ and xⱼ can be easily estimated in the input space as a Gaussian kernel evaluation, and in various examples, the inner product is specifically defined as [symbol] G(xᵢ,⋅), G(xⱼ,⋅) [symbol] =G(xᵢ, xⱼ). The [symbol] defined by the Gaussian kernel is infinite dimensional and nonlinearly related to the input data space S. For the case of data samples from stochastic processes, G(X(t),⋅) is a random function. To illustrate for the kernel least mean square (KLMS) algorithm, the nonlinear filter output is given by Equation 1.

yₙ=Σᵢ₌₁ⁿ⁻¹ηeᵢG(xₙ−xᵢ) Equation 1

In Equation 1, η represents the step-size, eᵢ represents the error at iteration i, and {xᵢ}ᵢ₌₁^{N} represent the past or historical data samples that constitute the “dictionary” to construct the output. It should be noted that the order of the filter grows linearly in time, if no sparsification is included. This KLMS algorithm uses gradient search to construct the optimal function Ω*, such that f*(x)= [symbol] G(x,⋅),Ω* [symbol] , and converges in the mean to the optimal least minimum square solution in [symbol] for small step sizes and large number of data samples. As will be appreciated, the appeal of the KLMS is that it does not need explicit regularization and is a convex and universal learning machine, or a CULM. However, a shortcoming of this kernel mapping is that it does not preserve the inner product in xᵢ; that is, [symbol] xₙ, xᵢ [symbol] ≠ [symbol] G(xₙ, ⋅), G(xᵢ, ⋅) [symbol] . For this reason, there cannot be a congruence map between these Hilbert spaces, which is the price paid by the nonlinear mapping that gives the universal approximation in [symbol] . In KAF applications, since the kernel evaluations are weighted by the error, there may exist an automatic way to preserve the scale of the representations when applying the kernel trick, but in other cases this may be a technical challenge.

The [symbol] defined by the Gaussian kernel differs from the [symbol] defined by the covariance kernel in at least four fundamental ways. First, a “linear” kernel [symbol] is used yielding a close-form optimal linear model in L₂, as is mentioned above. Second, the linear kernel is computed by employing the expected value over data lags s=t−τ to take advantage of the wide sense stationarity of the time series, unlike the pairwise sample set as [symbol] . The third difference is that the functions in [symbol] are stochastic if the data samples come from a random process, while the function in [symbol] are deterministic because of the congruence. Fourth, [symbol] is infinite dimensional, while [symbol] is defined by the number of lags of the covariance kernel, which are finite and small, as dictated by the input data dynamics.

Various embodiments address various technical limitations associated with the [symbol] defined by the Gaussian kernel and the [symbol] defined by the covariance kernel. In various embodiments, a new RKHS is defined that preserves the correlation structure defined by the data as [symbol] , but also maps the time series by a nonlinear kernel to achieve CULM properties, which will be denoted as [symbol] . To be practical, various embodiments may utilize the kernel trick to perform the various example computational operations in the input space. Generally, this solution is referred to herein as the functional Wiener filter, as it is solving directly the Wiener equation in [symbol] for strictly stationary discrete time stochastic processes.

### IV. Exemplary Operations

As discussed, various embodiments described herein provide a functional Wiener filter that is configured for nonlinear filtering and nonlinear prediction for continuous time series data. In various embodiments, the functional Wiener filter is practically implemented to enjoy various technical advantages, such as computation/processing efficiencies, reducing power consumption, and extended applicability to nonlinear data and functions, for example. In various embodiments, various example operations described for generating and/or implementing a functional Wiener filter may be performed by one or more data collection devices 110, which may be configured to collect continuous time series data and to process said data to produce filtered data. In various embodiments, various example operations described for generating and/or implementing a functional Wiener filter may be performed by one or more user computing entities 102 that may be in communication with the data collection devices 110 and that may support the data collection devices 110 by filtering collected data using the functional Wiener filter, storing historical data samples that may be used to generate the functional Wiener filter, generating and providing the functional Wiener filter to the data collection devices 110, and/or the like. Generally, the apparatus 200 comprises means for performing example operations described herein, and the data collection devices 110 and/or the user computing entities 102 may embody the apparatus 200 depending on the embodiment.

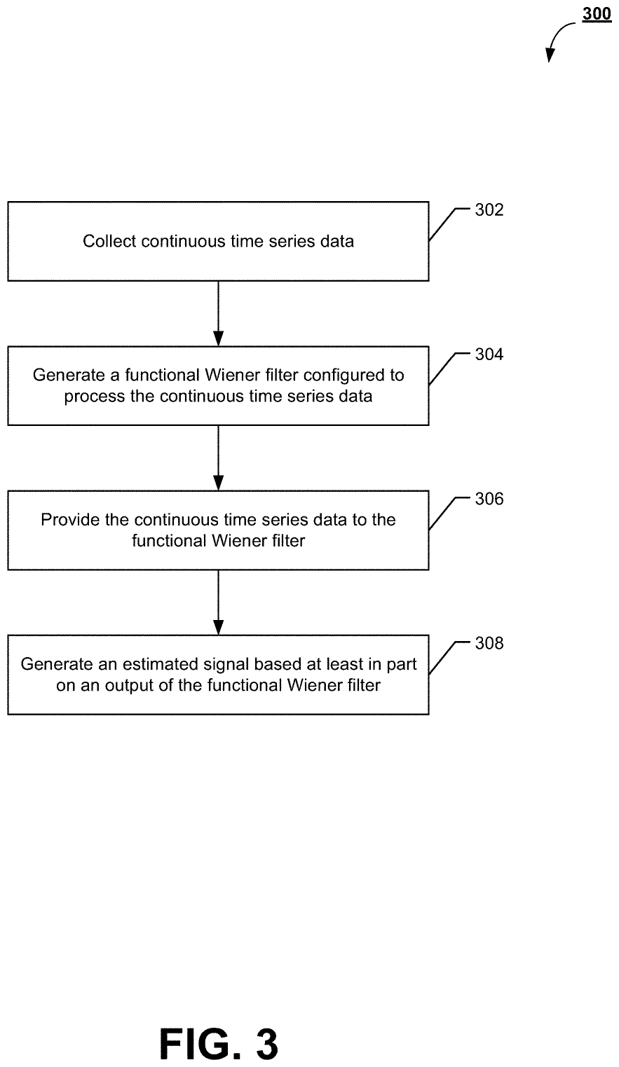

Referring now to FIG. 3, a flowchart of an example process 300 is illustrated. Process 300 includes example operations that may be performed by apparatus 200 (e.g., embodied by a data collection device 110, embodied by a user computing entity 102) in order to perform continuous time series data filtering using a functional Wiener filter. For example, the example operations may be performed for continuous time series data filtering applications including signal prediction and signal denoising. In various embodiments, the apparatus 200 comprises means, such as processing element 205, memories 210 and 215, network interface 220, and/or the like for performing at least the example operations of process 300.

Process 300 includes step/operation 302, at which continuous time series data is collected. In various embodiments, one or more data collection devices 110 comprise means for collecting continuous time series data. For example, continuous time series data may comprise sensor data streams collected by the one or more data collection devices 110. In some examples, a user computing entity 102 (e.g., a mobile device, a user equipment) is configured to collect continuous time series data and is a data collection device 110. In various embodiments, the continuous time series data may be collected in a discretized format, such as in an array, a matrix, a vector, and/or the like.

Process 300 includes step/operation 304, at which a functional Wiener filter is generated and configured for processing the continuous time series data. Generally, the functional Wiener filter is configured to generate and estimate an unknown signal based at least in part on the continuous time series data. Thus, the functional Wiener filter may be applied for signal prediction, signal denoising, and/or the like. In various embodiments, c The inner product is defined by the correlation of the kernel at two different lags and the mapping produces a single deterministic scalar for each element on the index set; that is, the practical dimension of [symbol] is the size of the index set. [symbol] has very technically advantageous properties for statistical signal processing and filtering. For example, [symbol] provides a straightforward way to apply optimal projection algorithms based at least in part on mean statistical embeddings that are expressed by inner products. As another example, the effective dimension of [symbol] is under the control of the designer by selecting the number of lags (just like the RKHS defined by the autocorrelation function). As yet another example, elements of [symbol] can be readily manipulated algebraically for statistical inference (e.g., without taking averages over realizations). [symbol] a further example, He is nonlinearly related to the input space, unlike the RKHS defined by the autocorrelation of the random process. Therefore, various embodiments apply the correntropy RKHS for nonlinear statistical signal processing.

Table 1 presents the different RKHSs defined in the present disclosure and their characteristics.

TABLE 1

| RKHS | Functional Mapping | Hilbert Space Characteristics |
|---|---|---|
| [symbol] _{R} Covariance | E[Xₜ,.] | Linear mapping of data, size of |
| | | lags, deterministic functions |
| [symbol] _{G} Gaussian | G(Xₜ,.) | Nonlinear mappings of data, |
| | | infinite, random functions |
| [symbol] _{\hat{v}} Correntropy | E[G(Xₜ,.),.] | Nonlinear mapping of data, size |
| | | of lags, deterministic functions |

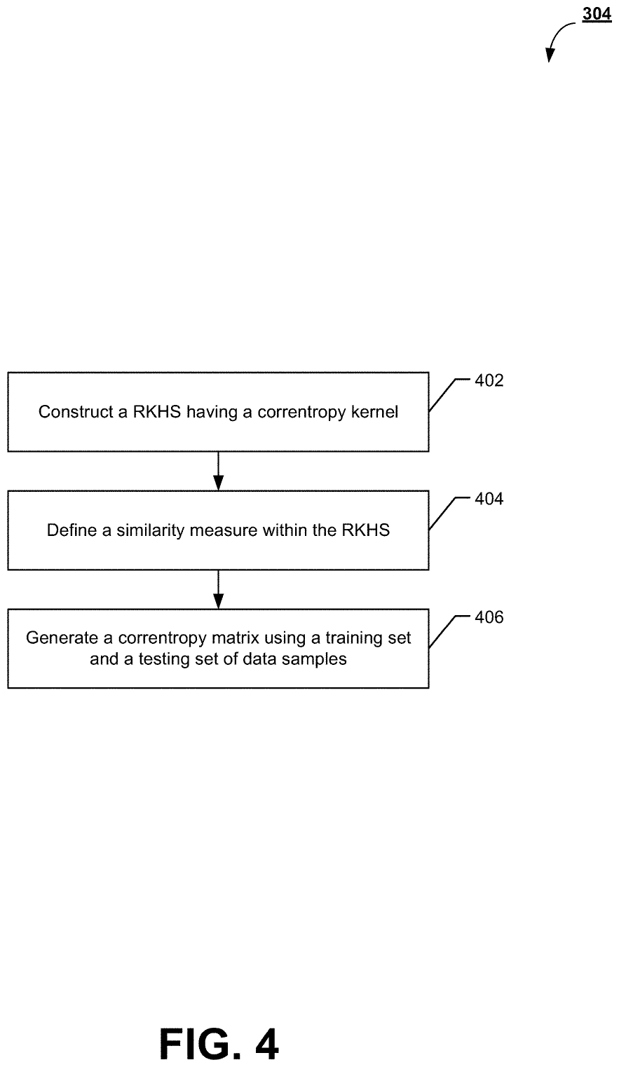

With the correntropy RKHS being constructed, a similarity measure is defined within the correntropy RKHS. As illustrated in FIG. 4, step/operation 404 comprise defining a similarity measure within the correntropy RKHS. In various embodiments, the similarity measure is a correntropy functional and uses [symbol] for computation in [symbol] . The following describes definition of the similarity measure.

The existence of [symbol] enables extension of concepts associated with the covariance RKHS that is defined on the Hilbert space of the data. Recall that the autocorrelation function of a time series is a similarity measure quantified by the mean value between the joint density of two random variables xᵢ, xᵢ at two different time intervals t₁, t₂. As such, it only measures the first moment (the mean) of the joint pdf over time. In various embodiments, the autocorrelation function is modified as a similarity measure in such a way that it captures all the statistical information contained in the joint distribution.

Other similarity measures are described and investigated herein. Given a strictly stationary time series {Xₜ, t∈T}, the equality in probability between two marginals at t₁ and t₂ e.g., P(xₜ₁=xₜ₂) is a measure of similarity that can be estimated in [symbol] . In the joint space of

$${p}_{{x}_{{t}_{1}} , {x}_{{t}_{2}}} ( {x}_{{t}_{1}} , {x}_{{t}_{2}} ) ,$$

a radial marginal can be defined as the bisector of the joint space. The density over the line xₜ₁=xₜ₂ represents P(xₜ₁=xₜ₂), which can be estimated according to Equation 5.

$$P ( {x}_{{t}_{1}} = {x}_{{t}_{2}} ) = {E}_{{p}_{{x}_{{t}_{1}} , {x}_{{t}_{2}}}} [ δ ( {x}_{{t}_{1}} - {x}_{{t}_{2}} ) ] \qquad Equation 5$$

In Equation 5, δ(⋅) is a delta function, and it can be assumed that the joint pdf over the lags is smooth along the bisector of the joint space and that the probability of P(xₜ₁) is non zero. The appendix shows that this is the numerator of the conditional probability of

$${p}_{{x}_{{t}_{1}}} ( {x}_{{t}_{1}} \vert {X}_{{t}_{2}} = {x}_{{t}_{1}} ) .$$

Dirac calculus illustrate this concept.

The expected value of Equation 5 can be written according to Equation 6.

$${E}_{{p}_{{x}_{{t}_{1}} , {x}_{{t}_{2}}}} [ δ ( {x}_{{t}_{1}} - {x}_{{t}_{2}} ) ] = \int \int δ ( {x}_{{t}_{1}} - {x}_{{t}_{2}} ) {p}_{{x}_{{t}_{1}} , {x}_{{t}_{2}}} ( {x}_{{t}_{1}} , {x}_{{t}_{2}} ) {dx}_{{t}_{1}} {dx}_{{t}_{2}} \qquad Equation 6$$

The meaning of Equation 6 is clear: the area under the joint distribution along the line xₜ₁=xₜ₂ is integrated. Because the random process is stationary,

$${p}_{{x}_{{t}_{1}}} = {p}_{{x}_{{t}_{2}}} ,$$

function is operated, the double integral reduces to one integral. Therefore, Equation 6 can be written as Equation 7.

$${E}_{{x}_{{t}_{1}} {x}_{{t}_{2}}} [ δ ( {x}_{{t}_{1}} - {x}_{{t}_{2}} ) ] = \int {p}_{{x}_{{t}_{1}} {x}_{{t}_{2}}} ( {x}_{{t}_{1}} , {x}_{{t}_{1}} ) {dx}_{{t}_{1}} \qquad Equation 7$$

With Equation 7, there is a scalar value that measures the area under the joint distribution along the bisector of the joint space. This reduction to a single integral can be expected by the definition of conditional pdf, and it simplifies the computation because effectively the statistical embedding in [symbol] is on a single random variable xₜ₁, despite starting with a two-dimensional pdf function.

However, this procedure has to be repeated for every lag L of interest; that is, t₂=t₁₋ₗ, l=0, . . . L. In various embodiments, the maximum lag L is advantageously dictated by the embedding dimension of the real system that produced the time series (e.g., a data collection device 110 collecting continuous time series data), which is far smaller than the number of samples that may be available for training and testing. In some examples, this order can be estimated by Takens' embedding theory, or more practically by selecting the first minimum of the time series autocorrelation function. This computation is much simpler than the covariance matrix shown in Equation 22 because the matrix is reduced to a vector u of size L, that contains the probabilities uₗ=P(xₜ₁=xₜ₁₋₁) at every lag. Thus, for two functions ƒ and g of dimension L in [symbol] , [symbol] f, u^{T}g [symbol] is simply computed. In various embodiments, the complexity of this computation is further simplified in [symbol] , as demonstrated within the present disclosure.

In various embodiments, the correntropy functional is used as an approximation to equality in probability; that is, in various embodiments, the similarity measure within the RKHS is defined as the correntropy functional. In particular, the natural measure of similarity in [symbol] is given by its inner product (Equation 4), which is coined in the correntropy functional, shown by Equation 8.

$${V}_{σ} ( {t}_{1} , {t}_{2} ) = {E}_{{p}_{{t}_{1}} {p}_{{t}_{2}}} [ {G}_{σ} ( {x}_{{t}_{1}} - {x}_{{t}_{2}} ) ] \qquad Equation 8$$

In Equation 8, G(⋅) represents the Gaussian function with bandwidth a. As discussed above, the correntropy functional is a mean embedding of the joint pdf of a pair of samples. Rewriting it using the definition of the expected value over the joint distribution, Equation 9 is obtained.

$${V}_{σ} ( {t}_{1} , {t}_{2} ) = \int \int {G}_{σ} ( {x}_{{t}_{1}} - {x}_{{t}_{2}} ) {p}_{{x}_{{t}_{2}} {x}_{{t}_{1}}} ( {x}_{{t}_{1}} , {x}_{{t}_{2}} ) {dx}_{{t}_{1}} {dx}_{{t}_{2}} = E [ {G}_{σ} ( {x}_{{t}_{1}} - {x}_{{t}_{1 + τ}} ) ] \qquad Equation 9$$

In various embodiments, Equation 9 applies for strictly stationary processes, where the substitution t₂=t_{1-τ} is made. The best way to interpret this equation is to realize that when xₜ₁=xₜ₂, e.g., along the bisector of the joint space, the Gaussian kernel function is maximum. That is, the correntropy functional weights the joint space of samples with Gaussian kernels placed along the bisector of the first quadrant. When the kernel size a approaches 0, it approximates a delta function δ(xₜ₁−xₜ₂), so that an approximation to Equation 7 is obtained. The details are shown in the appendix. Moreover, correntropy is easily computed from data samples too. Collect a segment of data of size N from a time series. From Equation 9, an estimator of correntropy is simply defined with Equation 10.

$${V}_{σ} ( τ ) = \frac{1}{N - τ + 1} {\sum }_{i = m}^{N} {G}_{σ} ( {x}_{i} - {x}_{i - m} ) \qquad Equation 10$$

Hence, correntropy effectively estimates equality in probability directly from samples with linear complexity. This is unsuspected, because similarity is quantified in the structure of a time series above what can be achieved with the mean value of the product of samples as autocorrelation. Note that here the kernel size should be made small for fine temporal resolution, but there is a compromise because if a very small kernel size is used, the number of samples N must be sufficiently large to get sufficient number of samples around the bisector of the joint space for accurate statistical estimation.

Thus, in various embodiments, the correntropy functional may be suitable as a similarity measure within the RKHS [symbol] . As illustrated in FIG. 4, step/operation 406 then comprises generating a correntropy matrix within the RKHS. In various embodiments, the correntropy matrix is generated based at least in part on generating a MMSE solution in [symbol] and using a training set of data samples. In doing so, let two segments of a time series with N samples be represented as xₛ and xₜ, and define s=t−τ, thus working on a domain of lags τ between data pairs. Let these two time series segments now be mapped to [symbol] , defining G(xₛ−xₜ)=G(xₜ−x_{t+τ}) for any t, τ∈[1, . . . , N] such that t−τ<N. This simplification is possible provided the time series is strictly stationary and becomes a function of the lag. Notice that the projected time series functional is still random in [symbol] . Accordingly, there is a family of vectors {ζₜ, t∈T} in the Hilbert space [symbol] that is a representation of a wide sense stationary time series {G (xₜ, ⋅), t∈T} for every t, r in T. Thus, Equation 11 can be defined because of the construction in Equation 4.

[symbol]

ζₜ,ζ_{t-τ} [symbol] =E[G(xₜ,x_{t-τ})] Equation 11

It can also be stated that there is a congruence ψ from L₂ (ζₜ, t∈T) onto L₂(G(xₜ,⋅),t∈T) satisfying ψ(ζₜ)=G(xₜ,⋅), such that every random variable G(xₜ,⋅) in L₂(G(xₜ,⋅),t∈T) may be written G(xₜ,⋅)=ψ(g) for some unique vector gin L₂(ζₜ,t∈T), which shows that the covariance structure of [symbol] is preserved.

Thus, to solve the MMSE problem in [symbol] to generate a correntropy matrix for a functional Wiener filter, consider ζₜ as the FWF input, as shown in Equation 12.

y(t)= [symbol] ρ_{z},ζₜ [symbol] Equation 12

In Equation 12, ζ=[G (xₜ, ⋅), G(x_{t-L+1},⋅)] T, and ρ_{z}=E[zₛζₛ], where zₛ is the desired scalar response sample at time s (a scalar), which takes the role of the unknown random variable Z for which the best approximation is sought.

This defines a close form functional Wiener filter solution in [symbol] . This functional Wiener filter solution is nonlinear in the input space, thus extending applicability of existing filtering techniques. A major difference to KAF and the (linear) Wiener filter in the data space, is that this functional Wiener filter solution does not use the error. The reason is that the existing techniques implicitly decorrelate the data and automatically find the orthogonal projection on the data manifold.

However, even with the functional Wiener filter solution in Equation 12, the congruence in Equation 11 cannot be extended to the original time series {Xₜ, t∈T}. This is shown in Equation 13.

[symbol]

ζₜ,ζ_{t-τ} [symbol] =E[G(xₜ,x_{t-τ})]≠E[xₜ,x_{t-τ}] Equation 13

In various examples, this is because the kernel mapping does not preserve the inner product in S; that is, (xₙ, xᵢ [symbol] ≠(G(xₙ,⋅),G(xᵢ, ⋅) [symbol] . For large kernel sizes such that the effective correlation time of xₙ, falls in the flat portion of the Gaussian function, the discrepancy between E[G(xₜ,x_{t-τ})] and E[xₜ,x_{t-τ}] is mostly the scale (the Gaussian's range is always between [0,1]), which can be remediated by a simple pointwise rescaling on ψ(g). However, for smaller kernel sizes, the problem is more difficult and may require compensation by extending the dimensionality of [symbol] , (number of lags), in some examples. In various embodiments, this means that L may need to be larger than the corresponding order for the design of the functional Wiener filter in the input space, because [symbol] must quantify the covariance structure in the functional space [symbol] for good results.

Accordingly, in various embodiments, the functional Wiener filter can be practically computed or generated in [symbol] based at least in part on a correntropy matrix, as indicated for step/operation 406. Doing so may be based at least in part on an assumption that the random functional ζₜ is ergodic, such that expected values can be estimated by temporal averages. Second, because of the congruence in Equation 11, [symbol] ζₜ, ζ_{t-τ} [symbol] can be substituted by E[G(xₜ,xₛ)] and by ergodicity, it can be estimated from samples over a window of length N samples.

y(t)= [symbol] ρ_{z},ζₜ [symbol] =(V⁻¹ρ_{z},ζₜ [symbol] Equation 14

In Equation 14, ζₜ can be written in [symbol] as

ζₜ=[G(xₜ,⋅), . . . ,G(x_{t-L+1},⋅)]^{T} Equation 15

Further, Equation 16 provides the correntropy matrix included in Equation 14 as

$$V = [ \begin{matrix}1 / N {\sum }_{i = 1}^{N} G ( {x}_{i} , {x}_{i} ) & … & 1 / N {\sum }_{i = 1}^{N} G ( {x}_{i} , {x}_{i - L + 1} ) \\ ⋮ & ⋱ & ⋮ \\ 1 / N {\sum }_{i = 1}^{N} G ( {x}_{i - L + 1} , {x}_{i} ) & … & 1 / N {\sum }_{i = 1}^{N} G ( {x}_{i - L + 1} , {x}_{i - L + 1} )\end{matrix} ] \qquad Equation 16$$

In various embodiments, the correntropy matrix is further distinguished from KAF, in which one needs to transfer vectors of samples to the RKHS where the size of the vectors is an estimate of the embedding dimension of the system that created the time series (e.g., a data collection device 110) using Takens' embedding theory. The reason is that the KLMS is a pairwise instantaneous algorithm, so if it is applied to each sample of the input data the algorithm loses the local time structure of the signal. For the functional Wiener filter, the data can be mapped to the RKHS sample by sample, as it is done in the input space, because the formulation uses the correntropy matrix where the lag structure is present. In various embodiments, the coefficients of the correntropy matrix are flipped in time, due at least in part to the functional Wiener matrix computing convolution in inner product spaces.

Equation 14 also includes a cross-correlation functional ρ_{z}, which can be estimated, in various embodiments. Using the same approximations as the ones for the correntropy matrix, Equation 17 shows an estimation for the cross-correlation functional.

$${\hat{ρ}}_{z} ( τ ) = \frac{1}{N} {\sum }_{t = 1}^{N} {G}_{σ} ( x ( t - τ ) , z ( t ) ) \qquad Equation 17$$

Equation 17 then provides a vector of size L (the number of lags of the correntropy matrix) including the relative weighting between the input vector xᵢ and the current value zᵢ of the desired signal (for signal prediction applications, zᵢ=xᵢ₊₁). This is the only term in Equation 12 that relates the target signal and the input signal, and it only needs to be evaluated during testing with test data samples. In testing, the optimum nonlinear filter can be computed directly from samples in [symbol] according to Equation 18.

w*=V⁻¹ρ_{z} Equation 18

During testing, the output of the optimal filter corresponds to an instance of the random element Σ_{τ=0}^{L-1}w*(τ)G_{σ}(X(t−τ)⋅), which is the best approximation to G_{σ}(Z,⋅), namely,

$${ξ}^{*} ( t ) = {\sum }_{τ = 0}^{L - 1} {w}^{*} ( τ ) {G}_{σ} ( {x}_{test} ( t - τ ) , \cdot ) \qquad Equation 19$$

where xₜₑₛₜ(t) is the test input at time t. This solution shares the form of the Wiener solution. The big difference is that the autocorrelation function was substituted by the correntropy function, while the input vector [x(t), x(t−1), . . . , x(t−L+1)] was substituted by a vector of functions nonlinearly related to the input space (the feature space defined by the Gaussian kernel). Notice that this solution is quite different from the KAF in several important ways. First, the optimal weight vector can be computed in the input space, and it appears as a scale factor to change the finite range of the Gaussian to span the values of the target response. Notice that this weighting depends on the actual local L sample history of the current input, but it is nonlinear and so it is more powerful than the linear weighting in linear Wiener filters. Second, there is no sum over the training set samples in the optimal solution like in KAFs. The best approximant is a combination of just L Gaussian functions centered at the current test sample, which is a major simplification in computation when compared with KAF.

In various embodiments, Equation 19 provides an improved solution for nonlinear time series, as it uses all the pdf information of the data and is computed in a Hilbert space nonlinearly related to the input, thus enabling universal approximation.

Ideally, the output of the FWF in the input space would correspond to the inverse map from [symbol] to [symbol] ^{d}, where d=1 in the simplest. Since Equation 19 expresses the optimal filter solution as a linear combination of Gaussian function, the goal is just to evaluate the function at a point in the input space, whose image is closest to the optimal solution. However, there is no guarantee such inverse map exists, so we must resort to an extra optimization or approximation step to find a pre-image of the optimal solution in the input space, as will be explained next.

For the FWF, the basic concept is to use an approximate pre-image in the input space of the optimal filter output in [symbol] i.e., the approximated FWF output to y*(t) will be given by:

$$y ( t ) = {arg min}_{y ∈ {ℝ}^{d}} {‖ {G}_{σ} ( y , \cdot ) - {ξ}^{*} ( t ) ‖}_{{ℋ}_{G}}^{2} \qquad Equation 20$$

This formulation can be applied in practical settings because in a training set, the optimal weight vector can be estimated using the V matrix from Equation 16 and the cross correntropy from Equation 17. Therefore, and according to Equation 20 it is only required to find the point to evaluate the optimal weight function, which is equivalent to find the minimum of

Σ_{τ=0}^{L-1}w*(τ)G_{σ}(xₜₑₛₜ(t−τ),y). Equation 21

Making the gradient of Equation 21 with respect to y equal to zero yields the fixed-point expression:

$${y}^{( i + 1 )} = \frac{{\sum }_{τ = 0}^{L - 1} {w}^{*} ( τ ) {G}_{σ} ( {x}_{test} ( t - τ ) , {y}^{( i )} ) {x}_{test} ( t - τ )}{{\sum }_{τ = 0}^{L - 1} {w}^{*} ( τ ) {G}_{σ} ( {x}_{test} ( t - τ ) , {y}^{( i )} )} , \qquad Equation 22$$

where y⁽ⁱ⁾ denotes the estimate of the preimage at the ith iteration of the fixed-point update. Notice that the nature of the pre-imaging solution involves a search on top of the analytic solution. This solution will be named FWF_{FP}.

An alternative approach for pre imaging is to find an input sample x(m) in the training set that when combined with the current input x(i), will produce an output in [symbol] that is close to its target z(i). Let us represent \hat{z}(i)=Σ_{τ=0}^{L-1}w*(t)G_{σ}(x(i−τ),x(m−τ)). The optimization can be written as

$$arg {min}_{x ( m ) ∈ S} ‖ z ( i ) - \hat{z} ( i ) ‖ \qquad Equation 23$$

where S is the training set. So, we need to implement a search (done once), where we find the sample pair (x(i),x(m)),i=1, N that produces the closest approximation to the target sample z(i). Once in testing, we find the closest sample x(i) in the training set to x(test) and use its neighbor x(m) to plug in Equation 19 to obtain the FWF output as

$$y ( t ) = \frac{{z}_{i}}{{\hat{z}}_{i}} {\sum }_{τ = 0}^{L - 1} {w}^{*} ( τ ) {G}_{σ} ( x ( m - τ ) , {x}_{test} ( t ) ) \qquad Equation 24$$

where the ratio zᵢ/\hat{z}ᵢ enforces the scale. This search needs to be done online for every test sample, but if we rank the training set, it can be done quickly with a tree search. This process can be repeated K times for a better approximation, where K is a hyper-parameter. The idea is to probe the neighborhood of x(test) with K input samples {x(1), . . . x(K)} and use their respective neighbors using Equation 23 to compute K approximate targets {\hat{z}(1), . . . .\hat{z}(K)} and represent their mean by z̅. The final FWF output will be

$$y ( t ) = {\sum }_{k = 1}^{K} \frac{{z}_{k}}{\overline{z}} {\sum }_{τ = 0}^{L - 1} {w}^{*} ( τ ) {G}_{σ} ( x ( k - τ ) , {x}_{test} ( t ) ) \qquad Equation 25$$

In terms of computational complexity, the two versions of FWF are a major improvement with respect to the KAF filters where the computation increases linearly with the number of iterations. When training the FWF, the complexity is equal to the Wiener filter e.g., O(NL²) to estimate the autocorrentropy matrix and the cross correlation vector (O(NL)), where N is the size of the training set and L the dimension of [symbol] . If the local model pre imaging is selected, there is the need to search the training set to find the closest pair to each sample to find the sample x(m) to implement Equation 23, which is linear complexity O(N). There is also the need to rank order the training set, but both searches need to be done just once. In the testing phase, Equation 24 is implemented with computational complexity of L samples, the dimensionality of [symbol] , i.e., also the same as the Wiener filter. For Equation 24 there are K models, so the computation is O(LK), and the input training data needs to be searched for the closest neighbor of the testing sample, which is O(log(N)) if the training data is pre ranked. On the other hand if the preimaging by optimization of Equation 22 is preferred, there is the fixed point update that requires only M=15˜20 iterations to stabilize;

Returning to FIG. 3, process 300 includes step/operation 306, at which the continuous time series data is provided to the functional Wiener filter for processing. Upon configuration, the functional Wiener filter is used to generate an output (e.g., yₜ using either Equation 22, Equation 23 or Equation 24) responsive to input data samples (e.g., xₜₑₛₜ in Equation 22, 23,24). In various embodiments, the input data samples are projected to the RKHS associated with the Gaussian kernel (e.g., [symbol] ) for application of the functional Wiener filter in the Gaussian RKHS to the input data, or the continuous time series data. In various embodiments, the continuous time series data comprises a plurality of time-discretized data samples that are provided in a sample-wise manner to the functional Wiener filter to obtain a filter output.

Process 300 includes step/operation 308, at which an estimated signal is generated based at least in part on an output of the functional Wiener filter. In various embodiments, the estimated signal may be a predicted signal, a denoised signal, and/or the like generated according to the continuous time series data. Then, in various embodiments, one or more post-filtering actions may be performed with the estimated signal. Post-filtering actions may include providing the estimated signal, such as a denoised signal, for display. For example, the continuous time series data is biometric data collected by a data collection device 110 configured to collect data from a patient (e.g., a smart watch, a health monitor device, and/or the like), and the estimated signal is a denoised portion of the collected data. The one or more post-filtering actions may include performing analytical actions with the estimated signal. In various embodiments, the estimated signal may be used to derive and generate one or more measurements (e.g., scalar measurements) according to the signal characteristics of the estimated signal.

### V. Example Experimental Implementation of Various Embodiments

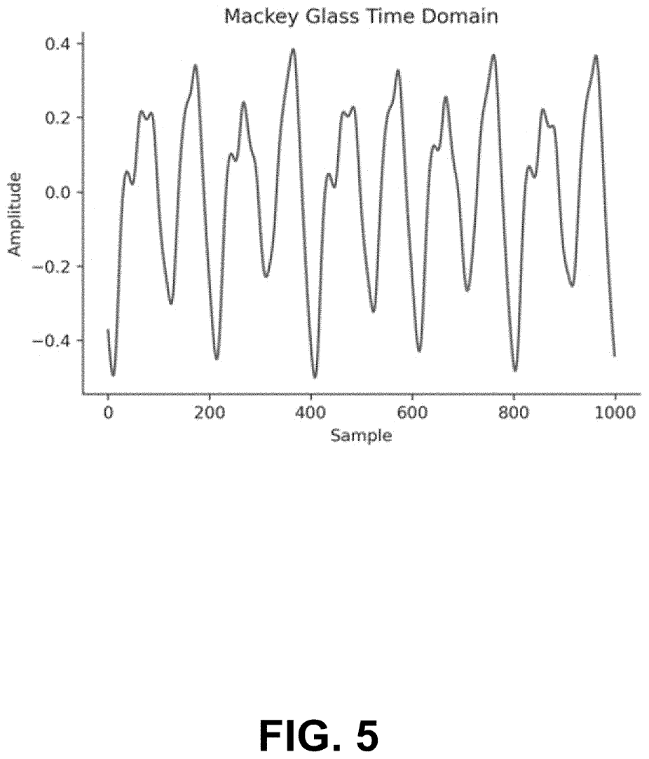

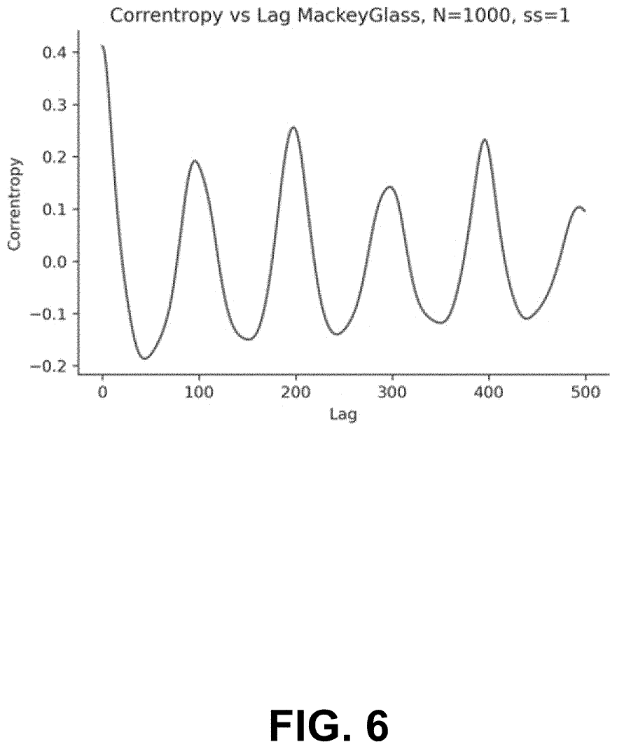

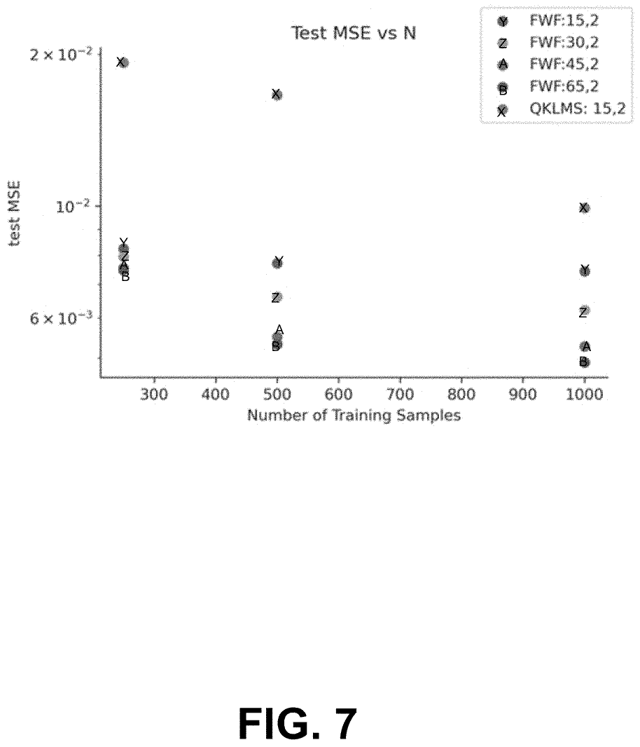

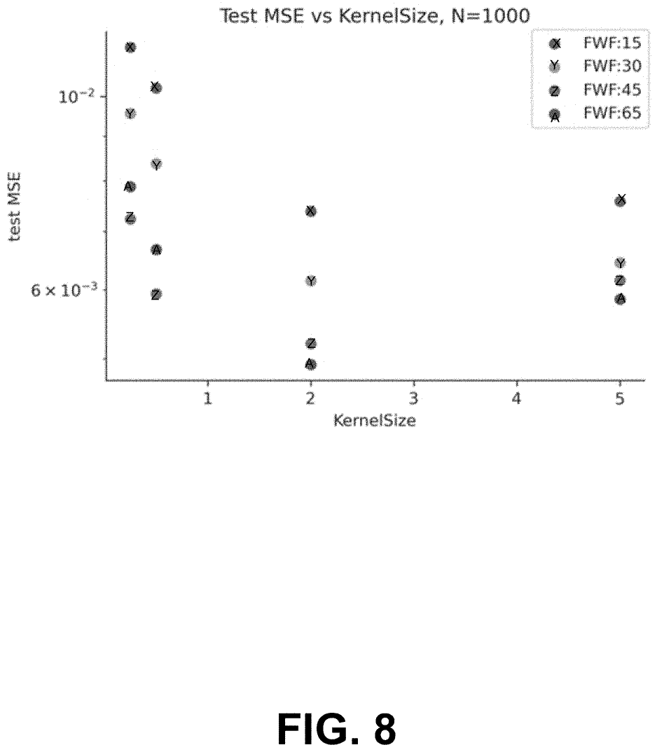

These experiments test the functional Wiener filter and KLMS on the Mackey-Glass (M-G) time series. The time domain desired test signal is shown in FIG. 5, and FIG. 6 illustrates the auto-correntropy function over 500 lags of the M-G time series. The goal of these experiments is twofold. First, it is desirable to show how the performance of the functional Wiener filter changes with respect to each of number of lags (L), number of training samples (N), and kernel size (σ). Second, these results should be fairly compared with KLMS. A kernel size of 2σ was selected for KLMS after a small search of values around Silverman's rule. The learning rate for KLMS was selected by searching values of 0.1-0.9 with a step size of 0.1. The best 11 found using this search was 0.1. FIG. 7 shows the test MSE for different numbers of training samples (N) for the functional Wiener filter at two different kernel sizes and for the KLMS. As shown in FIG. 7, the results show that the functional Wiener filter generally outperforms KLMS. FIG. 8 illustrates the test MSE as a function of kernel size (σ) for functional Wiener filters with different numbers of lags (L). At the smaller kernel size, more lags increased performance of FWF, but at the larger kernel size, functional Wiener filters with less lags had the best performance. In general, the larger kernel size gave the best performance for functional Wiener filters.

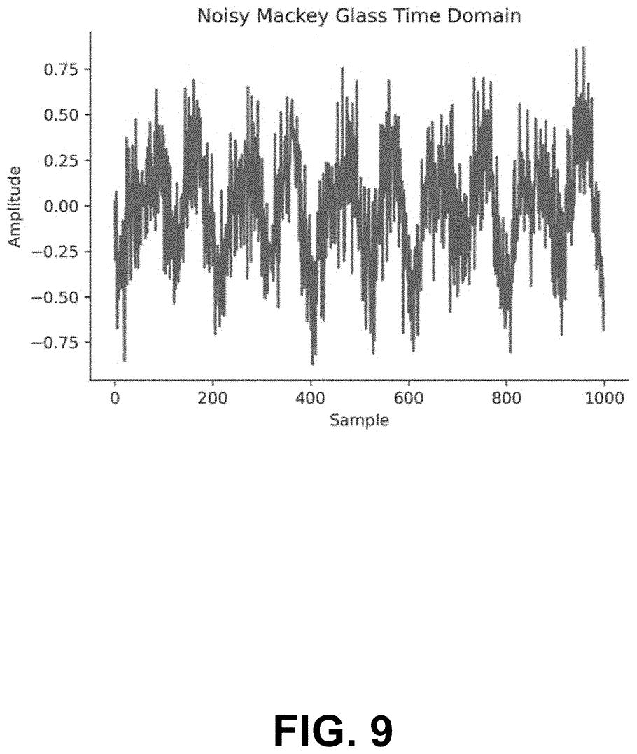

Meanwhile, experimental evaluation showed that larger kernel sizes may be associated with worse performance in the denoising task, in some examples. The denoising experiments test the functional Wiener filter and KLMS on a harder task of denoising the M-G time series. The added noise was white Gaussian noise (WGN) with a variance of 0.1. The noisy versions of the M-G time series are given as inputs in the experiments, and FIG. 9 illustrates an example noisy M-G time series. The desired signals are clean versions of the input signal for training. A seed was used so that the same WGN is added to the test and train signal in both FWF and KLMS experiments. A coarse search for the best learning rate (ii) was done for KLMS. The 11 was varied between values 0.1-0.9 with a step size of 0.1. The best 11 for this task was found to be 0.43.

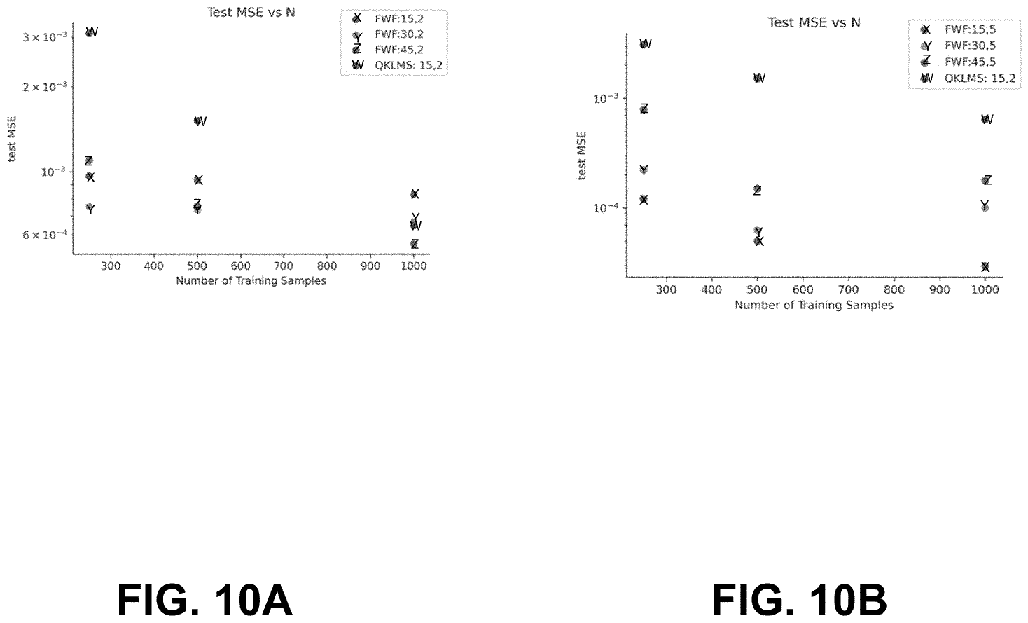

Kernel sizes are given in terms of a scaling factor on the kernel size given Silverman's rule. For example, a kernel size of 5 may be understood as 5σ Silverman. The kernel sizes of 0.25, 0.5, 1, 2, and 5 were tested for both the functional Wiener filter and KLMS. The best kernel size for both KLMS and functional Wiener filter was 2. The results of this experiment illustrated in FIGS. 10A and 10B show that the functional nonlinear Wiener-based filtering outperforms KLMS in this denoising task. One thing to note however is that the trend of results in KLMS suggests that for higher Nit may outperform the functional Wiener filter. The MSE curves of the functional Wiener filter suggest that performance is not increasing much with N, but does increase with L. Further, the performance of the functional Wiener filter is shown as a function of kernel size. As illustrated, performance of the functional Wiener filter is improved for the kernel size of 2 (shown in FIG. 10A), compared to a kernel size of 5 (shown in FIG. 10B). This result is different from the time series prediction task where performance increased as kernel size increased.

Accordingly, as described and as shown through experimental evaluation, various embodiments of the present disclosure provide technical advantages through functional nonlinear Wiener-based filtering, which can be applied in continuous time series data filtering (e.g., signal prediction, signal denoising). Various embodiments utilize a functional Wiener filter that is associated with improved computational and processing efficiency, reduced power consumption, and wider applicability with nonlinear functions and data. As such, various embodiments of the present disclosure are well-suited for implementation and efficient time series filtering in constrained devices, such as small-scale data collection devices, FPGAs, ASICs, IoT devices, and/or the like.

### VI. Conclusion

Details on additional concepts related to various embodiments are provided and described in the appendix found at the conclusion of this document, which is herein incorporated by reference.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A method comprising:
generating, by one or more processing elements, a correntropy matrix using a training set of data samples and a testing set of data samples;
generating, by the one or more processing elements, a functional Wiener filter based at least in part on the correntropy matrix;
receiving, by the one or more processing elements, continuous time series data;
generating, by the one or more processing elements, projected continuous time series data by projecting the continuous time series data to a reproducing kernel Hilbert space associated with a Gaussian kernel;
generating, by the one or more processing elements, an estimated signal associated with the continuous time series data by applying the functional Wiener filter to the projected continuous time series data; and
initiating, by the one or more processing elements, performance of one or more post-filtering actions based at least in part on the estimated signal.

2. The method of claim 1, wherein the functional Wiener filter is configured with a correntropy function.

3. The method of claim 2, wherein the correntropy function is configured to measure equality in probability distributions across different lags of the continuous time series data.

4. The method of claim 3, wherein the correntropy matrix is generated based at least in part on estimating the equality in probability distributions between the training set and a data sample of the testing set.

5. The method of claim 1, wherein the correntropy matrix is defined within a reproducing kernel Hilbert space associated with a correntropy kernel.

6. The method of claim 5, wherein the correntropy kernel comprises a dimension based at least in part on a number of lags.

7. The method of claim 6, wherein generating the functional Wiener filter comprises generating an estimation of a cross-correlation functional based at least in part on the number of lags.

8. The method of claim 1, wherein the correntropy matrix is configured to be invariant for different numbers of samples for the continuous time series data.

9. The method of claim 1, wherein the estimated signal comprises a predicted portion of the continuous time series data.

10. The method of claim 1, wherein the estimated signal comprises a denoised portion of the continuous time series data.

11. An apparatus comprising one or more processors and at least one memory storing instructions that, with the one or more processors, cause the apparatus to:
generate a correntropy matrix using a training set of data samples and a testing set of data samples;
generate a functional Wiener filter based at least in part on the correntropy matrix;
receive continuous time series data;
generate projected continuous time series data by projecting the continuous time series data to a reproducing kernel Hilbert space associated with a Gaussian kernel;
generate an estimated signal associated with the continuous time series data by applying the functional Wiener filter to the projected continuous time series data; and
initiate performance of one or more post-filtering actions based at least in part on the estimated signal.

12. The apparatus of claim 11, wherein the functional Wiener filter is configured with a correntropy function.

13. The apparatus of claim 12, wherein the correntropy function is configured to measure equality in probability distributions across different lags of the continuous time series data.

14. The apparatus of claim 13, wherein the correntropy matrix is generated based at least in part on estimating the equality in probability distributions between the training set and a data sample of the testing set.

15. The apparatus of claim 11, wherein the correntropy matrix is defined within a reproducing kernel Hilbert space associated with a correntropy kernel.

16. The apparatus of claim 15, wherein the correntropy kernel comprises a dimension based at least in part on a number of lags.

17. The apparatus of claim 16, wherein generating the functional Wiener filter comprises generating an estimation of a cross-correlation functional based at least in part on the number of lags.

18. The apparatus of claim 11, wherein the correntropy matrix is configured to be invariant for different numbers of samples for the continuous time series data.

19. The apparatus of claim 11, wherein the estimated signal comprises a predicted portion of the continuous time series data.

20. The apparatus of claim 11, wherein the estimated signal comprises a denoised portion of the continuous time series data.

21. A non-transitory computer readable storage medium comprising instructions that, with one or more processors, cause an apparatus to:
generate a correntropy matrix using a training set of data samples and a testing set of data samples;
generate a functional Wiener filter based at least in part on the correntropy matrix;
receive continuous time series data;
generate projected continuous time series data by projecting the continuous time series data to a reproducing kernel Hilbert space associated with a Gaussian kernel;
generate an estimated signal associated with the continuous time series data by applying the functional Wiener filter to the projected continuous time series data; and
initiate performance of one or more post-filtering actions based at least in part on the estimated signal.
